(19) United States
(12) Patent Application Publication
(10) Pub. No.: US 2007/0025049 A1
(43) Pub. Date: Feb. 1, 2007

(54) Assembly protection device for an aircraft component

(76) Inventors: Eckehard Zuendorf, Jork (DE); Wolfgang Erdmann, Buxtehude (DE)

Correspondence Address: OSTROLENK FABER GERB & SOFFEN, 1180 AVENUE OF THE AMERICAS, NEW YORK, NY, 100368403, US

(21) Appl. No.: 11/195,124

(22) Filed: Aug. 2, 2005

Related U.S. Application Data
(60) Provisional application No. 60/598,270, filed on Aug. 3, 2004.

(30) Foreign Application Priority Data
Aug. 3, 2004 (DE) 10 2004 037559.3

(51) Int. Cl. H05F 3/00

(52) U.S. Cl. 361/218

(57) ABSTRACT

Nowadays during assembly, foil or adhesive tape is used to protect bearings in passenger door fittings. An assembly protection device for an aircraft component is stated, which assembly protection device comprises a sealing device. In this way the assembly protection device can simply be firmly slid into the component to be protected so that effective sealing during assembly is ensured. Furthermore, the assembly protection device is reusable.

### REFERENCE TO RELATED APPLICATIONS

This application claims the benefit of the filing date of U.S. Provisional Patent Application No. 60/598,270 filed Aug. 3, 2004, the disclosure of which is hereby incorporated herein by reference and of German Patent Application DE 10 2004 037 559.3 filed Aug. 3, 2004, the disclosure of which is hereby incorporated herein by reference.

### FIELD OF THE INVENTION

The present invention relates to assembly protection devices. In particular, the present invention relates to an assembly protection device for an aircraft component; to the use of an assembly protection device when installing an aircraft component; and to an aircraft comprising a corresponding assembly protection device.

### BACKGROUND OF THE INVENTION

During the installation or assembly of aircraft components, large quantities of particles are released due to metal cutting and machining with the use of abrasive paper, which metal cutting often takes place. During such work, for example the passenger door fittings are already installed. Because the passenger door is not yet in place, the bearing ball situated in the fitting can freely rotate. Rotation of the ball results in exposure of the bearing shell. Consequently, extraneous particles can find their way to the surface which is moistened with lubricant. Furthermore, small extraneous particles can also enter by way of the gap between the ball and the shell as a result of the permissible bearing tolerance.

If a bearing that is blocked by particles is loaded under operational conditions, damage to the ball and shell will occur. This can result in malfunction of the bearing or even in its failure. The passenger door concerned can then only be opened with increased force, which in an emergency situation may contribute to increased time being required for evacuation.

It thus becomes necessary to replace the damaged fitting with a new component. This can result in considerable additional effort for installation, assembly or maintenance and thus leads to considerable costs.

In order to protect these bearings, adhesive tape or aluminium foil is used which is wrapped around the fittings to protect them from extraneous-particle ingress during installation. However, the adhesive tape can leave corrosion-causing residues on the ball surface. Furthermore, aluminium foil provides only inadequate protection because it is not a dust-proof system and furthermore permits the bearing ball to be rotated. In particular, aluminium foil is extremely sensitive to mechanical influences and can thus easily be torn so that the desired protective effect is destroyed. Adhesive tape is associated with another disadvantage in that its removal on completion of component installation often provides difficulties. Multiple use of these protection devices is not possible.

### SUMMARY OF THE INVENTION

According to an exemplary embodiment of the present invention, an assembly protection device for a component of an aircraft is provided, which component comprises a sealing device with an upper region and a lower region. To this effect the lower region of the sealing device can be slid into a recess of the component, and the component can be covered by the upper region of the sealing device after the lower region has been slid in.

The assembly protection device may provide effective protection of the component to be installed as part of carrying out structural installations in an aircraft. In this arrangement the assembly protection device according to the invention is adapted to the component to be protected; wherein merely its lower region has to be slid, at least partly, into the component to be protected, after which the component is reliably protected against dirt ingress and mechanical damage, with such protection taking place by means of the upper region of the assembly protection device or the sealing device. Furthermore, by sliding the lower region into the component, arresting of the component can advantageously be achieved, as a result of which any undesirable displacement or de-adjustment of the component may be prevented.

According to a further exemplary embodiment of the present invention, the lower region of the sealing device has a cross section, wherein the cross section of the lower region corresponds to the recess of the component so that after the lower region has been slid into the recess, the lower region establishes a non-positive connection with the component.

The non-positive connection between the lower region of the sealing device and the component may result in the sealing device or the assembly protection device being firmly seated in the component to be protected so that it is not displaced even under mechanical load as can occur during assembly. Furthermore, by adapting the sealing device to the recess, simple handling and assembly of the assembly protection device becomes possible with one hand. Furthermore, no further tools, such as for example knives for cutting off adhesive tape or the like, are required for installing the protection device.

According to a further exemplary embodiment of the present invention, the assembly protection device also comprises a tensioning element, wherein the tensioning element is designed to adjust a clamping force between the lower region of the sealing device and the component.

The tensioning element can be used to improve the strength of the seat of the sealing device in the recess of the component to be protected, or it can be used to reduce the strength of the seat after the component is installed in the aircraft so that the protection device can be removed. Reuse of the assembly protection device is thus possible.

According to a further exemplary embodiment of the present invention, setting the adhesive force between the lower region of the sealing device and the component takes place by the tensioning element squeezing the lower region, or by the tensioning element sliding the lower region along an inclined plane relative to a centre axis of the lower region.

Squeezing or wedging provides a simple mechanism to increase the retention force of the sealing device in the component. Sliding together the lower region results in shortening of this region and thus in a continuous enlargement so that the lower region pushes with increased strength onto the surface of the recess. In this way the adhesive force between the sealing device and the component increases so that a firm seat of the assembly protection device is ensured.

According to a further exemplary embodiment of the present invention, the tensioning element is designed in the shape of a screw or a quick-acting closure, wherein the retention force can be adjusted by turning the screw or by operating a lever of the tensioning element.

This provides simple and quick adjustment of the retention force. The quick-acting coupling may be operated without the use of a tool so that assembly is possible also in difficult conditions.

According to a further exemplary embodiment of the present invention, the aircraft component is a spherical bearing. The assembly protection device may thus be used for protecting bearing balls as used in bearings of passenger door fittings. Furthermore, sliding the lower region into the recess of the bearing ball effectively prevents rotation of the bearing ball.

According to another exemplary embodiment of the present invention, the assembly protection device also comprises a sealing ring, wherein the sealing ring is attached to the upper region of the sealing device and wherein, after the lower region of the sealing device has been slid into the recess, the sealing ring largely seals off a surface of the component. The use of a sealing ring is believed to provide a reliable, flexible and simple seal between the sealing device and the component, which seal excels in particular by providing fully dust-proof sealing of the top of the bearing.

According to a further exemplary embodiment of the present invention, the assembly protection device essentially comprises plastic, a light metal alloy or a nonferrous metal alloy. These materials excel in particular by their low weight and/or by the ease with which they can be processed with metal cutting tools.

According to a further exemplary embodiment of the present invention, a method for affixing an assembly protection device with a sealing device to an aircraft component is provided, wherein the method comprises the steps of:

sliding a lower region of the sealing device into a recess of the component, and covering the component by the upper region after sliding-in the lower region.

### BRIEF DESCRIPTION OF THE DRAWINGS

Below, the invention is described in more detail by means of exemplary embodiments with reference to the drawings.

FIG. 1 shows a diagrammatic sectional view of an assembly protection device according to an exemplary embodiment of the present invention.

FIG. 2 shows a diagrammatic sectional view of the assembly protection device of FIG. 1, in the tensioned state.

FIG. 3 shows a diagrammatic sectional view of an assembly protection device according to a further exemplary embodiment of the present invention.

FIG. 4 shows a diagrammatic sectional view of the assembly protection device of FIG. 3, in the tensioned state.

FIG. 5 shows a diagrammatic sectional view of an assembly protection device, which is slid into a bearing ball, according to an exemplary embodiment of the present invention.

### DESCRIPTION OF PREFERRED EMBODIMENTS OF THE INVENTION

In the following description of the figures, identical reference characters are used for identical or similar elements.

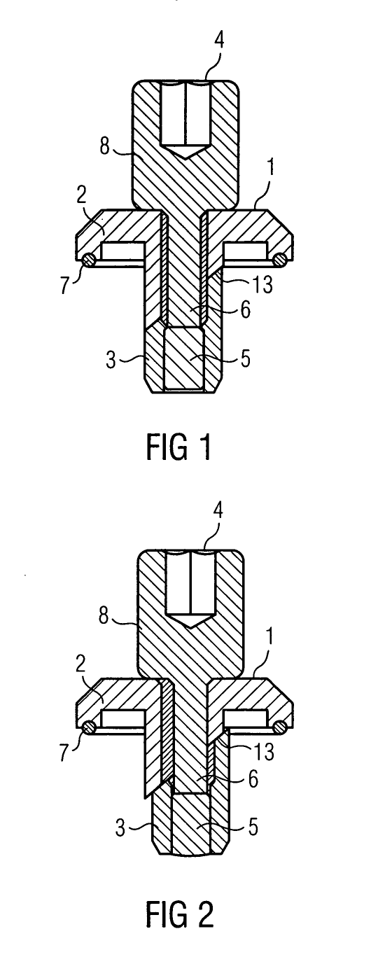

FIG. 1 shows a diagrammatic sectional view of an installation or assembly protection device for an aircraft component, according to one embodiment of the present invention. As shown in FIG. 1, the assembly protection device comprises a sealing device 1 with an upper region 2 and a lower region 3. Furthermore, the assembly protection device comprises a tensioning element 4 comprising a head region 8, a counterpart 5 and a pin 6.

The lower part of the sealing device or lower region 3 of the assembly protection device shown in FIG. 1 is inserted into a borehole or recess of a component to be protected (not shown in FIG. 1) until the sealing ring 7 rests against the top of the component. This component can for example be a bearing ball which forms part of a door fitting.

In this embodiment the cross section of the lower region 3 corresponds to the cross section of the recess of the component into which the lower region is slid. This ensures that the lower region 3, after it has been slid into the recess, can establish a non-positive connection with the component. In this arrangement it is not necessary for the cross section of the lower region to have the same form as the cross section of the recess. For example it is imaginable that the cross section of the recess is round, that the recess is thus in the shape of a cylindrical borehole, while the cross section of the lower region 3 is for example hexagonal in shape. Of course the cross section of the lower region 3 can also be round.

Furthermore, the assembly protection device comprises a tensioning element 4 which is used to adjust an adhesive force, retention force, clamping force or frictional force between the lower region 3 of the sealing device and the component. The tensioning element 4 shown in FIG. 1 is designed in the form of a screw connection comprising a head region 8, a pin 6 with a thread, and a counterpart 5 with a corresponding counter thread. The head region 8 of the tensioning element can comprise a knurl. In this arrangement the threaded pin 6 and the head region 8 are firmly interconnected. By turning the pin 6 in the corresponding direction, the counterpart 5, which is for example a nut with a washer, moves in the direction of the upper region 2. This leads to the lower region 3 being squeezed, or a wedge 3 being displaced along the plane 13, which leads to a corresponding shortening and thickening of the lower region. This is shown in FIG. 2.

FIG. 2 shows a diagrammatic sectional view of the assembly protection device of FIG. 1, in the tensioned state. As shown in FIG. 2 the screw device or the tensioning element 4 is tightened, as a result of which the lower region 3 is squeezed or slid along an inclined plane relative to the centre axis, which results in a widening of its cross sectional area. The lower region 3 comprises for example a plastic or rubber material with a borehole, through which the pin 6 of the tensioning element 4 passes. By widening the lower region 3, a non-positive connection between the assembly protection device and the component to be protected (not shown in FIG. 2) can be established.

By way of corresponding adjustment of the tensioning element 4 the adhesive force between the assembly protection device and the component to be protected can be adjusted as desired. Likewise, it is possible, by corresponding activation of the tensioning element 4 (undoing the screw arrangement) to undo the non-positive connection between the component and the assembly protection device so that the assembly protection device can subsequently be withdrawn from the recess.

Furthermore, the assembly protection device shown in FIGS. 1 and 2 comprises a sealing ring 7, which is attached to the upper region 2 of the sealing device 1. The sealing ring 7 can for example be a rubber ring. Of course, other sealing materials are also imaginable. After the lower region 3 has been slid into the recess of the component, the sealing ring 7 provides a tight seal to the surface of the component. This effectively prevents any ingress of extraneous matter such as for example metal shavings or chemicals. In this way damage to or soiling of the bearing during assembly is prevented.

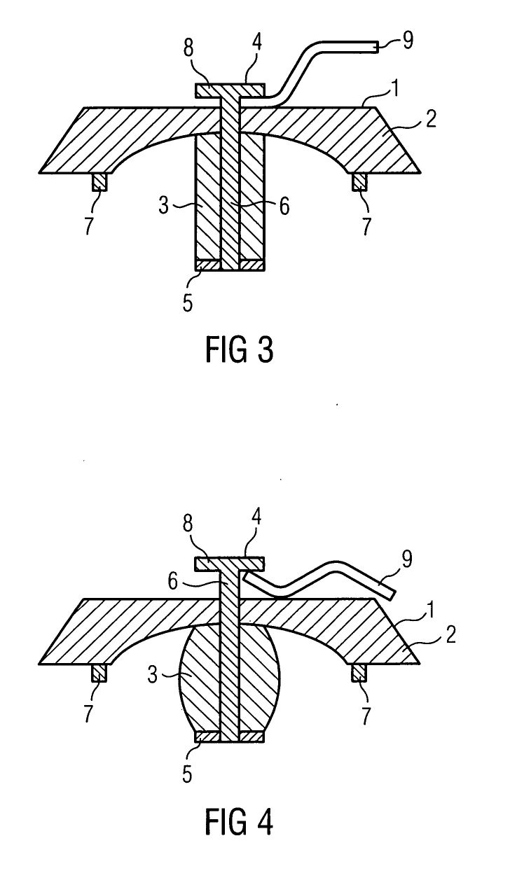

FIG. 3 shows a diagrammatic sectional view of an assembly protection device for a component of an aircraft, according to a further embodiment of the present invention. As shown in FIG. 3 the tensioning element 4 further comprises a lever 9. Thus the tensioning element 4 and the lever 9 form a type of quick-acting closure. By activating the lever 9, the head of the tensioning element 8 and thus the pin 6 attached thereto can be pushed upward together with the washer 5. This is shown in FIG. 4.

FIG. 4 shows a diagrammatic sectional view of the assembly protection device from FIG. 3, in its tensioned state. The lever 9 of the tensioning element 4 is activated, which causes the combination of tensioning element head 8, pin 6 and counterpart 5 to be slid upward. As a result of this, the lower region 3 of the sealing device 1 is squeezed or displaced, and becomes correspondingly thicker. By increasing the diameter of the lower region 3, the holding force between the assembly protection device and the component to be protected can be increased so that the strength with which the assembly protection device is seated in the component is increased.

Of course, the lever 9 is but one possible embodiment for tensioning the tensioning element 4 accordingly. In particular spring mechanisms are also imaginable in this context. Of course it is also possible to do without an extra tensioning element 4. This is for example the case where the cross section of the lower region 3 is sufficiently large that it has to be pressed, from the outset, into the recess of the component to be protected, even without extra tension of the clamping element 4, and thus where the adhesive force between the component and the assembly protection device is sufficient without any assistance.

The upper region 2 can be made from a light metal alloy or a nonferrous metal alloy or for example also from plastic. In the case of a tensioning function as a result of squeezing, the lower part 3 can be made from elastic rubber materials. In the case of a tensioning principle by sliding a wedge, a material with a lower coefficient of friction and increased strength is advantageous.

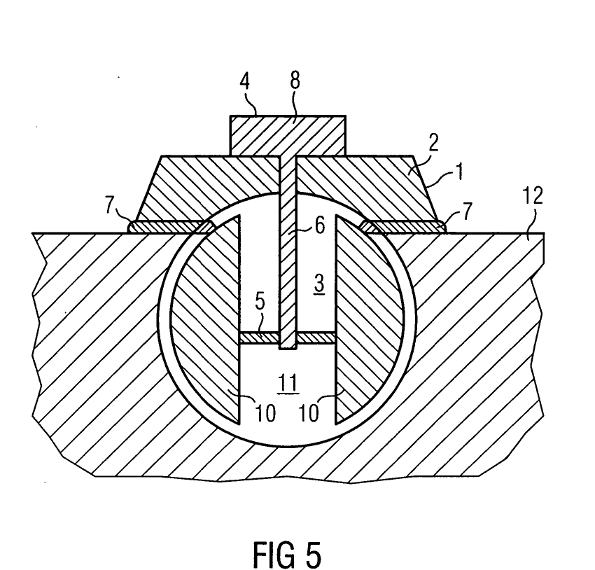

FIG. 5 shows a diagrammatic sectional view of an assembly protection device which has been installed in a bearing ball of a passenger door fitting. In this arrangement the bearing ball 10 comprises a cylindrical borehole 11, into which the lower region 3 of the sealing device 1 can be inserted. The assembly protection device is arranged so as to be rotation-symmetric on the longitudinal axis of the pin 6. As shown in FIG. 5, the rubber seal 7 rests firmly on the surface of the bearing ball 10 and on the surface of the bearing shell 12. To this effect the tensioning element 4 is tightened accordingly so that the nut 5 and the tensioning element head 8 squeeze the lower region 3 of the sealing device 1. The lower region 3 thus presses against the wall of the recess 11, ensuring that the assembly protection device cannot be displaced.

In this way the bearing is protected against rotation of the ball, and thus against exposure of the bearing shell 12, because the upper region 2 prevents rotation of the ball, which is installed in the bearing shell 12 of the door bearing, relative to an axis perpendicular to the longitudinal axis of the pin 6. Furthermore, the assembly protection device shown in FIG. 5 provides complete dust-free sealing of the bearing surface. By undoing the tensioning element 4 and releasing or correspondingly reducing the adhesive force between the lower region 3 and the bearing ball 10, the assembly protection device can subsequently be withdrawn from the recess 11. It is therefore possible to re-use the assembly protection device for installing a component in an aircraft.

Implementation of the invention is not limited to the preferred embodiments shown in the figure. Instead, a multitude of designs are imaginable which use the solution shown and the principle according to the invention even in the case of fundamentally different embodiments.

In addition it should be pointed out that “comprising” does not exclude other elements or steps, and “one” does not exclude a plural number. Furthermore, it should be pointed out that characteristics or steps which have been described with reference to one of the above embodiments can also be used in combination with other characteristics or steps of other embodiments described above. Reference characters in the claims are not to be interpreted as limitations.

What is claimed is:

1. An assembly protection device for an aircraft component, comprising:
a sealing device;
wherein the sealing device comprises an upper region and a lower region;
wherein the lower region is slidable into a recess of the component; and
wherein the component is removable by the upper region of the sealing device after the lower region has been slid in.

2. The assembly protection device of claim 1,
wherein the lower region of the sealing device has a cross section; and
wherein the cross section of the lower region corresponds to the recess of the component so that after the lower region has been slid into the recess, the lower region establishes a non-positive connection with the component.

3. The assembly protection device of claim 1, further comprising:
a tensioning element;
wherein the tensioning element is adapted to adjust an adhesive force or clamping force between the lower region of the sealing device and the component.

4. The assembly protection device of claim 3,
wherein a setting of the adhesive force between the lower region of the sealing device and the component is performed by the tensioning element squeezing the lower region, or by the tensioning element sliding the lower region along an inclined plane relative to a centre axis of the lower region.

5. The assembly protection device of claim 3,
wherein the tension element is designed in the shape of a screw or a quick-acting closure; and
wherein the retention force can be adjusted by turning the screw or by operating a lever of the tensioning element.

6. The assembly protection device of claim 1,
wherein the aircraft component is a spherical bearing.

7. The assembly protection device of claim 1, further comprising:
a sealing ring;
wherein the sealing ring is attached to the upper region of the sealing device; and
wherein after the lower region of the sealing device has been slid into the recess, the sealing ring seals off a surface of the component.

8. The assembly protection device of claim 1,
wherein the assembly protection device essentially comprises a plastic material, a light metal alloy or a nonferrous metal alloy.

9. The use of an assembly protection device of any one of the preceding claims, for assembly of an aircraft component.

10. An aircraft comprising an assembly protection device of claim 1.

11. A method for affixing an assembly protection device with a sealing device to an aircraft component, wherein the method comprises the steps of:
sliding a lower region of the sealing device into a recess of the component, and
covering the component by the upper region after sliding-in the lower region.

12. The method of claim 11, further comprising the step of:
setting a retention force between the lower region of the sealing device and the component by means of a tensioning element;
wherein the lower region of the sealing device has a cross section; and
wherein the cross section of the lower region corresponds to the recess of the component so that after the lower region has been slid into the recess the lower region establishes a non-positive connection with the component.
